(19) United States
(12) Patent Application Publication
(10) Pub. No.: US 2010/0289470 A1
(43) Pub. Date: Nov. 18, 2010

(54) Power Supplying Method for LCD Display Device and Power Supply Device

(76) Inventors: Yi-Shang Chen, Taipei Hsien (TW); Chun-Hao Hsu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/690,939

(22) Filed: Jan. 21, 2010

(30) Foreign Application Priority Data
May 12, 2009 (TW) 098115670

(51) Int. Cl. G05F 1/10; G09G 5/00

(52) U.S. Cl. 323/282; 345/208; 345/211

(57) ABSTRACT

A power supply device of a LCD display device comprising an AC rectifier; a square wave generator; an AC voltage converting module, coupled to the square wave generator, for providing an AC voltage to a backlight module of the LCD display device; and a plurality of DC voltage converting modules, for providing a plurality of voltage sources to a plurality of load circuits of the LCD display device, each DC voltage converting module comprising a control circuit for masking off the first oscillating signal, to generate a second oscillating signal according to a feedback signal of a corresponding load circuit; a voltage converting unit, coupled to the control circuit and the load circuit, for transforming the second oscillating signal into a voltage source for the load circuit; and a feedback control unit, coupled to the control circuit and the load circuit, for generating the feedback signal.

### BACKGROUND OF THE INVENTION

1. Field of the Invention

The present invention is related to a power supply method of a LCD display device capable of reducing system cost and power supply devices, and more particularly, to a power supply method of the LCD display device which can reduce number of power components and power supply devices

2. Description of the Prior Art

Most home electronics or information products have their own power supply devices, which are utilized for transforming the AC (alternating current) power source into the various voltage levels required by all the circuit components of the products. For example, the power supply device of a desk-top computer is utilized for converting the AC power source into several different levels of DC (direct current) voltages, and those DC voltages are then delivered via bunches of copper wires to some major parts, like the motherboard, the HDD (hard disk drive), the optical disk drive . . . etc. Taking the motherboard as an example, after the motherboard receives the DC voltages from the power supply device, the motherboard will perform the secondary or even more stages of voltage conversion to produce the required voltages for the operational needs of the CPU, the DRAM modules, the network IC, and so forth. For a complex power supply system like this, more power-related components are required for performing the complete power supply functions.

However, the desk-top computer mentioned above is not a unique example; many other home appliances also have complex power supply devices and components. For instance, a LCD (liquid crystal device) TV which is getting much popular in the recent years is another convenient example. The power supply device of the LCD TV also exhibits a hierarchical structure. Please refer to FIG. 1, which illustrates a block diagram of a power supply device 10 of a LCD TV of the prior art. The power supply device 10 comprises a primary power unit PPU0, a backlight power unit BLPUO and a main board power unit MBPU0. The primary power unit PPU0 comprises a rectifier RECT0, a pulse wave modulation (PWM) control unit PCU0, a power stage PS0 and a DC converter DCCU0. The rectifier RECT0 is utilized to receive an AC voltage ACin from the home electric power outlet, and to generate a DC voltage DCP0 correspondingly. The PWM control unit PCU0 converts the DC voltage DCP0 into a PWM signal PWM_S0 by performing the pulse width modulating (PWM) technique. Next, the power stage PS0 will perform the low-pass filtering function on the PWM signal PWM_S0 and convert it into a DC voltage DCP1, and the DC converter DCCU0 is then utilized to convert the DC voltage DCP1 into the DC voltages DCP2 and DCP3, which are then directed to the backlight power unit BLPU0 and the main board power unit MBPU0, respectively. The major function of the backlight power unit BLPU0 is to convert the DC voltage DCP2 into an AC voltage BLAC1 of about 1.5 KV (kilo-volt), for driving the light tube in the backlight module. On the other hand, the major function of the main board power unit MBPU0 is to convert the DC voltage DCP3 into a number of DC voltages ranged from 1.2 volts to 8 volts for providing every component on the main control board with the desired level of operating voltages.

In detail, the backlight power unit BLPU0 comprises a pulse wave modulation (PWM) control unit PCU1, a power stage circuit PS1, an AC converter ACIU1 and a voltage transformer PVTU1. Firstly, the PWM control unit PCU1 converts the DC voltage DCP2 into a PWM signal PWM_S1, and the power stage circuit PS1 converts the PWM signal PWM_S1 into a DC voltage DCP4. Next, the DC voltage DCP4 is converted into an AC voltage BLAC0 by an AC converter ACIU0. Finally, the voltage transformer PVTU1 converts the AC voltage BLAS0 into a high voltage level of AC voltage BLAC1, and the AC voltage BLAC1 is utilized to drive the light tube in the backlight module.

Besides that, the main board power unit MBPU0 comprises a pulse wave modulation (PWM) control unit PCU2, a power stage circuit PS2 and a number of DC converters DCCU1˜DCCUN. About the operation, the PWM control unit PCU2 converts the DC power DCP3 into the PWM signal PWM_S2, and then the power stage circuit PS2 converts the PWM signal PWM_S2 into a DC power DCP5. Finally, use the DC converters DCCU1˜DCCUN to convert the DC power DCP5 into a number of DC voltages DC1˜DCN between 1.2 to 8 volts to supply the DC voltages required by the proper operations of every component on the main control board.

According to the description above, the power supply device of the prior art comprises multiple stages of voltage/current conversion, such that all the required DC voltages can be provided for every single circuit component in the main control board, and also the AC voltage can be supplied for driving the light tube of the backlight module. Among them, the power supply device 10 uses three pulse wave modulation (PWM) control units PCU0˜PCU2 in total for handling the voltage/current conversion and power regulation for the electronic components on the backlight module and the main control board. Since more stages of voltage conversion will undoubtedly decrease more of the electric efficiency, therefore for a power supply system of the LCD TV or other electronic product, to explore the way(s) to improve the efficiency of the voltage/current conversion, and to decrease the wasting of the electric energy and lower the overall cost of the product has been a major goal for global industry.

### SUMMARY OF THE INVENTION

It is therefore a primary objective of the claimed invention to provide a power supply method for LCD display device and power supply device for saving power components and reducing system cost.

The present invention discloses a power supply device of a LCD (liquid crystal device) display device for saving power components and reducing system cost, which comprises an AC (alternating current) rectifier, coupled to an AC power source, for transforming the AC power source into a DC power source; a square wave generator, coupled to the AC rectifier, for generating a first oscillating signal according to the DC power source; an AC voltage converting module, coupled to the square wave generator, for providing an AC voltage to a backlight module of the LCD display device; and a plurality of DC voltage converting modules, for providing a plurality of voltage sources to a plurality of load circuits of the LCD display device, each DC voltage converting module comprising a control circuit, coupled to the square wave generator, for masking off the first oscillating signal, to generate a second oscillating signal according to a feedback signal of a corresponding load circuit; a voltage converting unit, coupled to the control circuit and the load circuit, for transforming the second oscillating signal into a voltage source for the load circuit; and a feedback control unit, coupled to the control circuit and the load circuit, for generating the feedback signal.

The present invention further discloses a power supply method for saving power components and reducing system cost, which comprises a power supply method, for supplying a voltage source to a load circuit, comprising generating a first oscillating signal; masking the first oscillating signal to generate a second oscillating signal according to a feedback signal of the load circuit; and transforming the second oscillating signal into the voltage source for the load circuit.

The present invention further discloses a power supply device, used for supplying a voltage source to a load circuit, comprising a square wave generator, for generating a first oscillating signal; a control circuit, coupled to the square wave generator, for masking off the first oscillating signal, to generate a second oscillating signal according to a feedback signal of the load circuit; a voltage converting unit, coupled to the control circuit and the load circuit, for transforming the second oscillating signal into a voltage source for the load circuit; and a feedback control unit, coupled to the control circuit and the load circuit, for generating the feedback signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a block diagram of a power supply device of a LCD TV of the prior art.

FIG. 2A illustrates a schematic diagram of a power supply device of a LCD display device according to an embodiment of the present invention.

FIG. 2B illustrates a schematic diagram of an AC voltage/current converting module shown in FIG. 2A.

FIG. 2C illustrates a functional block diagram of each of DC voltage/current converting modules shown in FIG. 2A.

FIG. 3 illustrates a schematic diagram of waveforms of oscillation signals generated by a square wave generator shown in FIG. 2A and waveforms after being masked off by a control circuit shown in FIG. 2A.

FIG. 4 illustrates a power supplying process according to the present invention.

FIG. 5 illustrates a schematic diagram of a power supply device according to an embodiment of the present invention.

FIG. 6A˜6B illustrate circuit diagrams of the power supply device shown in FIG. 5 according to an embodiment of the present invention.

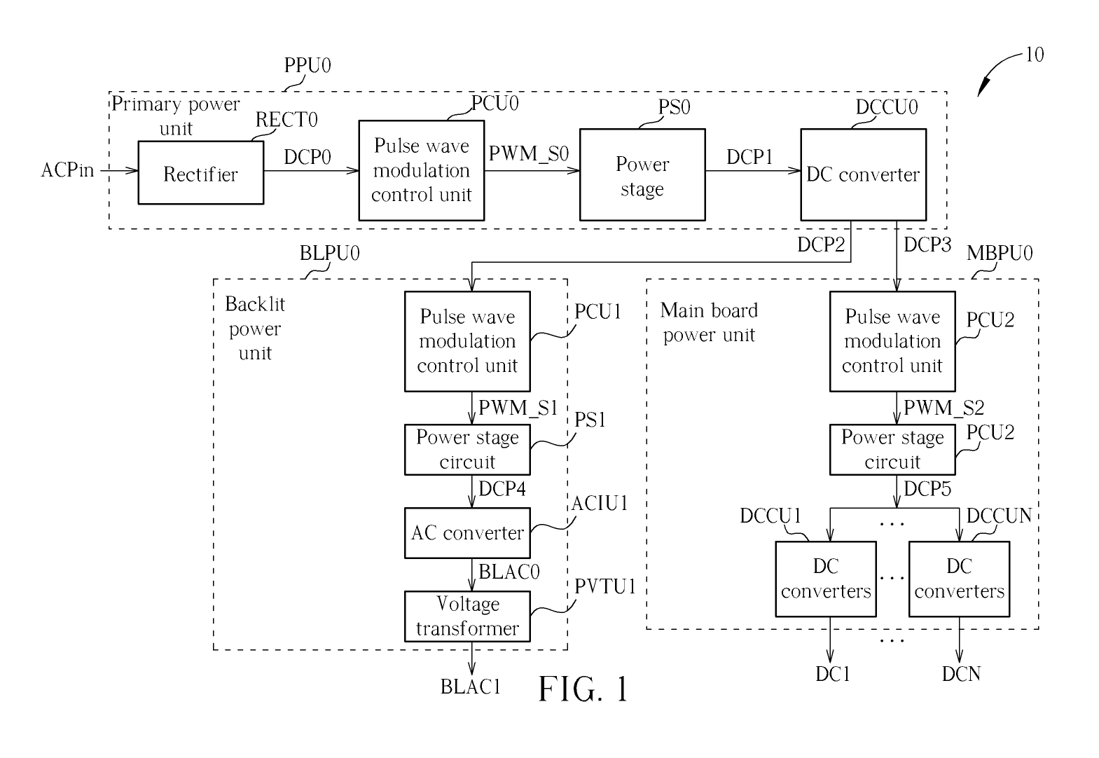

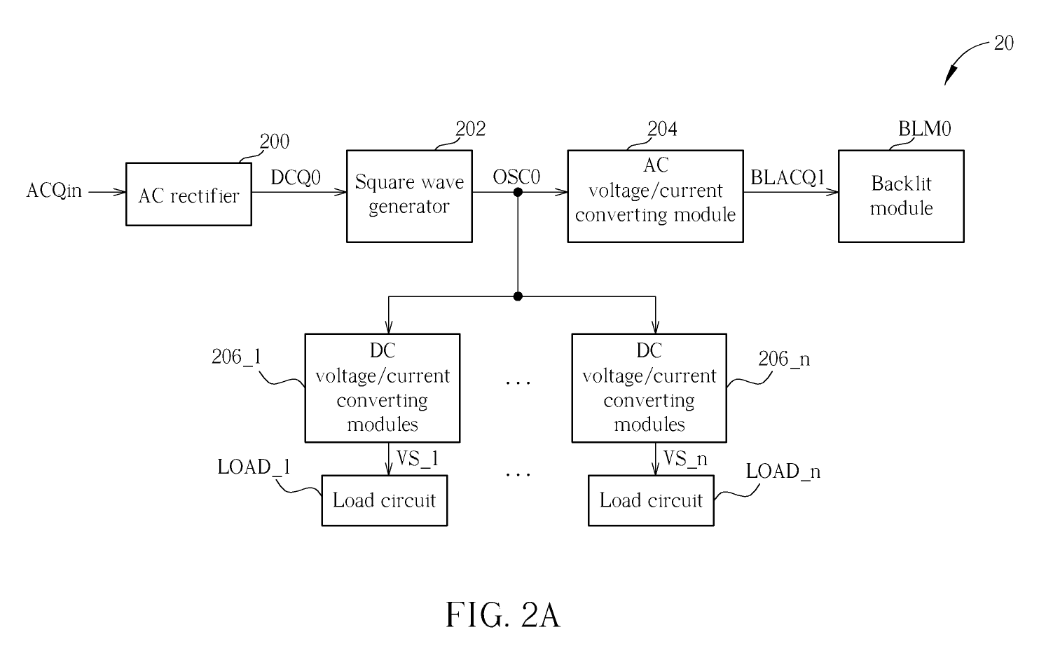

### DETAILED DESCRIPTION

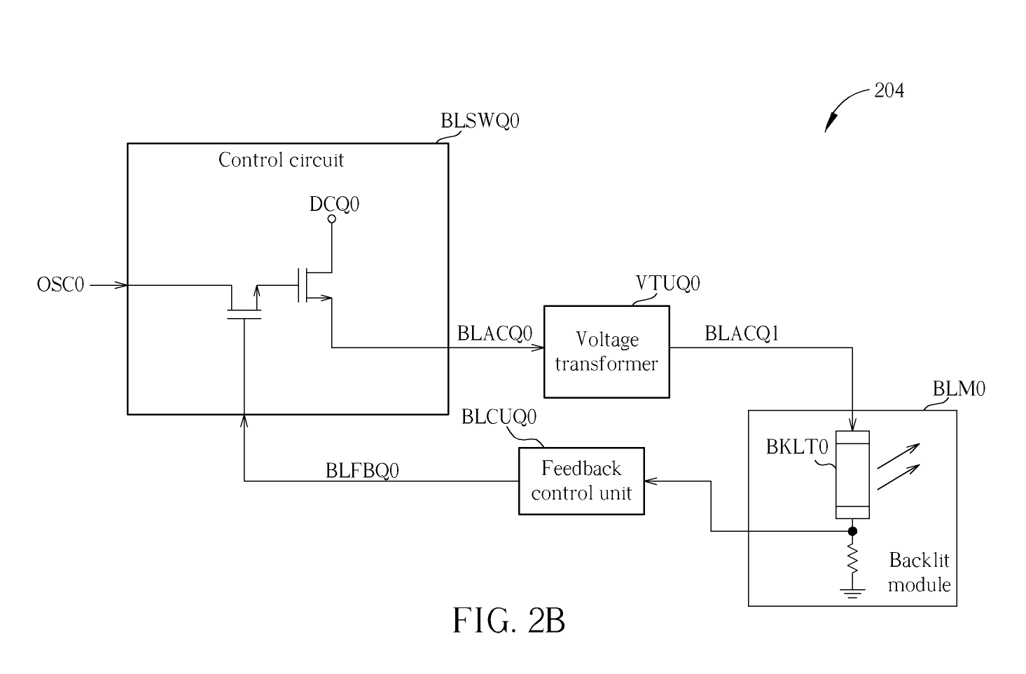

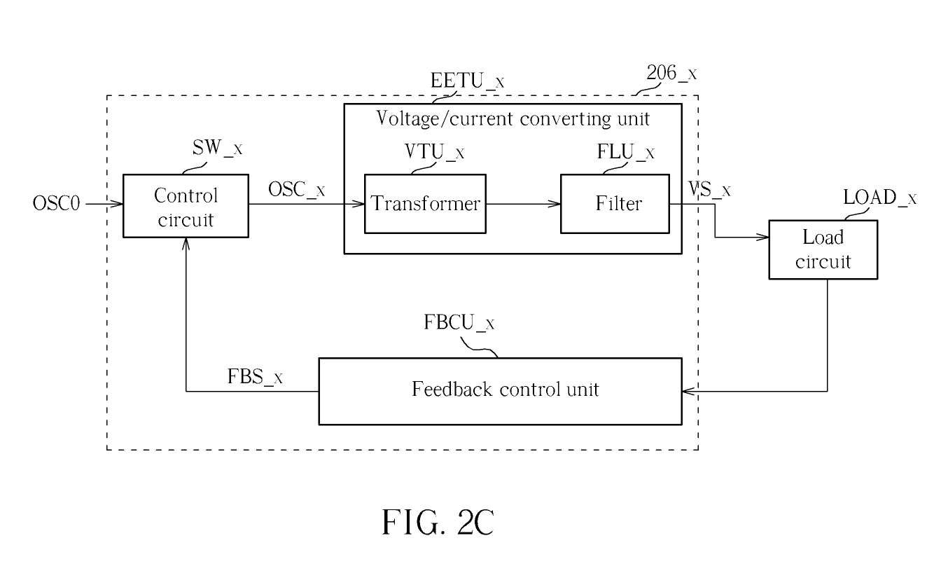

Please refer to FIG. 2A, which illustrates a schematic diagram of a power supply device 20 of a LCD display device according to an embodiment of the present invention. The power supply device 20 comprises an AC rectifier 200, a square wave generator 202, an AC voltage/current converting module 204 and DC voltage/current converting modules 206_1˜206_n. The AC rectifier 204 comprises functions of AC rectifying and ripple filtering, and is utilized to convert an AC power source ACQin into a DC power source DCQ0. Preferably, the AC power source ACQin is an AC power coming from a home electric power outlet. Next, the square wave generator 202 receives the voltage/current provided by the DC power source DCQ0 to generate an oscillating signal OSC0. Preferably, the oscillating signal OSC0 is a series of square wave signals, and the duty cycle of the square wave signal is preferably a constant. On the other hand, the AC voltage/current converting module 204 is utilized to provide an AC power source BLACQ1 to a backlight module BLM0 of the LCD display device, and the DC voltage/current converting modules 206_1˜206_n are utilized for providing DC voltage sources VS_1˜VS_n to load circuits LOAD_1˜LOAD_n of the LCD display device.

Firstly, the operating principles of providing the AC voltage/current to the backlight module BLM0 are to be explained. Please refer to FIG. 2B, which illustrates a schematic diagram of the AC voltage/current converting module 204 according to an embodiment of the present invention. The AC voltage/current converting module 204 comprises a control circuit BLSWQ0, a voltage transformer VTUQ0 and a feedback control unit BLCUQ0. The control circuit BLSWQ0 is utilized to mask the oscillating signal OSC0 according to a feedback signal BLFBQ0 provided by the backlight module BLM0, and to output an AC oscillating signal BLACQ0 to the voltage transformer VTUQ0. The control circuit BLSWQ0 of this embodiment of the present invention comprises a switch and a power output circuit. The voltage transformer VTUQ0 is utilized to elevate the voltage of the AC oscillating signal BLACQ0 to a 1.5 KV (kilo-volt) of AC power source BLACQ1, and to drive a light tube BKLT0 of the backlight module BLM0. Besides that, the feedback control unit BLCUQ0 generates the feedback signal BLFBQ0 according to the current level of the light tube BKLT0.

According to the explanation above, the operating principles of the AC voltage/current converting modules 204 can be detailed as follows. Firstly, the square wave generator 202 generates the oscillating signal OSC0 with its frequency ranged from 100 to 200 KHz (kilo-Hertz), and the control circuit BLSWQ0 is designed to regulate number of square waves being passed according to the feedback signal BLFBQ0 of the feedback control unit BLCUQ0. In other words, the control circuit BLSWQ0 can regulate the amount of energy being delivered to the backlight module BLM0 from the square wave generator 202 according to the feedback signal BLFBQ0, and to decide whether to mask off the oscillating signal OSC0 according to the current level of the light tube BKLT0. On the other hand, the AC voltage/current converting module 204 utilizes the feedback control unit BLCUQ0 to detect the magnitude of current flowing through the light tube BKLT0, and to generate the feedback signal BLFBQ0, and to utilize the feedback signal BLFBQ0 to control the switching operations of the control circuit BLSWQ0. Since the oscillating signal OSC0 of the present invention can be regulated and its voltage can be increased, and directly output to the light tube BKLT0 with a voltage of proper current level. Therefore, as can be observed, the power supply architecture of the backlight module of the present invention can discard most of the voltage/current conversion stages of the prior art. To detail further, in the backlight module power unit BLPU0, only the transformer VTUQ0 of the prior art can find an analogous or comparable component in the present invention, which is the voltage transformer PVTU1, the rest of the components are all saved. In other words, about the parts used in the power supplying function to the backlight module power unit BLPU0, the PWM control unit PCU1, the power stage circuit PS1 and the AC converter ACIU1 of the prior art can all be saved, so the power consumption can be lowered and the cost can be decreased. Noteworthily, the waveform of the oscillating signal OSC0 is no longer a continuous series of square wave after being regulated by the control circuit BLSWQ0; therefore, according to the present invention, the voltage waveform utilized to drive the light tube BKLT0 and the florescent light emitted from the light tube BKLT0 are no longer a continuous train of pulses. On the contrary, some pulses are being masked off. According to the experiment, the percentage of the square waves being masked off by the control circuit BLSWQ0 is relatively small and is scattered in the temporal domain, such that an ordinary user won't notice any flickering phenomena or feel uncomfortable by watching the LCD display device using the power supply device according to the present invention.

Please refer to FIG. 2C, which illustrates a functional block diagram of any DC voltage/current converting module 206_x of the DC voltage/current converting modules 206_1˜206_n according to an embodiment of the present invention. The DC voltage/current converting module 206_x comprises a control circuit SW_x, a voltage/current converting unit EETU_x and a feedback control unit FBCU_x. The control circuit SW_x masks off the oscillating signal OSC0 to generate an oscillating signal OSC_x according to a feedback signal FBS_x. The voltage/current converting unit EETU_x is utilized to convert the oscillating signal OSC_x into a DC voltage source VS_x, and supply the load circuit LOAD_x with the required voltage(s). The feedback control unit FBCU_x is utilized to generate a feedback signal FBS_x. Preferably, the feedback control unit FBCU_x is to detect the magnitude of the current flowing through the load circuit LOAD_x and to generate a feedback signal FBS_x, and to mask off the oscillating signal OSC0 via controlling the control circuit SW_x. Finally, the voltage/current converting unit EETU_x comprises a transformer VTU_x and a filter FLU_x. The transformer VTU_x is utilized to change the voltage level of the oscillating signal OSC_x to generate an oscillating signal QOSC_x, and the filter FLU_x is utilized to convert the oscillating signal QOSC_x into a DC voltage source VS_x, and provide it to the load circuit LOAD_x.

To detail more, the DC voltage/current converting module 206_x utilizes the oscillating signal OSC0 generated by the square wave generator 202, and performs the waveform regulating process by the control circuit SW_x contained in the DC voltage/current converting module 206_x. In other words, the DC voltage/current converting module 206_x utilizes the control circuit SW_x to regulate the energy transportation from the square wave generator 202 to the load circuit LOAD_x. Furthermore, the regulated oscillating signal OSC_x will be transformed into the DC voltage VS_x via the transformer VTU_x and the filter FLU_x. On the analogy of this, the DC voltage/current converting module 206_1˜206_n can produce all the DC voltages VS_1˜VS_n required by the load circuit LOAD_1˜LOAD₁₃ n. Noticeably, FIG. 2C is a schematic diagram of a DC voltage/current converting module 206_x, and those skilled in the art will readily observe that numerous alternations can be made accordingly. For example, the control circuit SW_x can be a MOSFET, with its drain, gate and source coupled to the square wave generator 202, the feedback control unit FBCU_x and the voltage/current converting unit EETU_x, respectively. Also, the load circuit LOAD_1˜LOAD_n are preferably utilized to represent the related circuit components of the LCD display device. Noteworthily, compared with the prior art, the PWM control unit PCU2 of the main board power unit MBPU0 can be saved, such that the power consumption can be saved and the cost can be decreased.

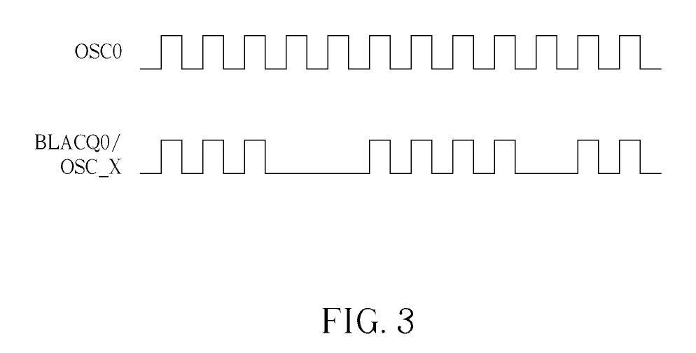

For easily demonstrate the difference of the original oscillating waveform OSC0 and the waveforms being masked by the control circuit BLSWQ0 or the control circuits SW_1˜SW_n of the DC voltage/current converting module 206_1˜206₁₃ n, please refer to FIG. 3, which illustrates a schematic diagram of the waveform of the oscillation signal OSC0 generated by the square wave generator 202 and the waveform after being masked off by the control circuits BLSWQ0 and SW_1˜SW_n. As can be seen in FIG. 3, the oscillating signal OSC0 is to mask off part of the voltage/current via controlling the control circuit BLSWQ0 and SW_1˜SW_n, so the energy being masked off can not be transported to the load; in fact, the purpose of masking the voltage/current is for controlling the output voltage such that stable output voltages can be obtained for various load conditions.

Briefly speaking, the present invention is to apply the oscillating signal generated by the square wave generator, via a control circuit for regulating the square wave voltage and a transformer, to directly provide the AC voltage/current for the light tube of the backlight module; also, by using the same oscillating signal, and by applying the simple regulating and filtering process, the oscillating signal can be converted to the DC voltages to supply the needs of ordinary circuit components. Compared with the prior art, the present invention is capable of greatly decreasing the number of the circuit components and simplifying the complexities of the power supply architecture, but still achieving the equivalent functions and system performance.

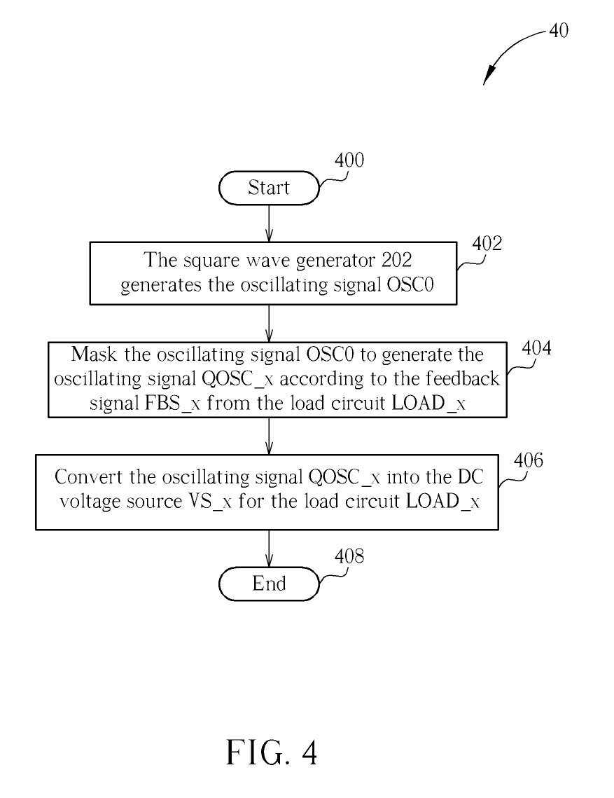

According to the explanation above, the operations of any DC voltage/current converting module 206_x can be derived to become a power supplying process 40, as specified in FIG. 4. The power supplying process 40 is used for supplying DC voltage source VS_x to the load circuit LOAD_x, and comprises the following steps:

STEP 400: Start.

STEP 402: The square wave generator 202 generates the oscillating signal OSC0.

STEP 404: Mask the oscillating signal OSCO to generate the oscillating signal QOSC_x according to the feedback signal FB_x from the load circuit LOAD_x.

STEP 406: Convert the oscillating signal QOSC_x into the DC voltage source VS_x and supply to the load circuit LOAD_x.

STEP 408: End.

The power supplying process 40 is used for demonstrating the operations of the DC voltage/current converting module 206_x, more details about the working principles can be found in the explanations above, and won't be detailed further.

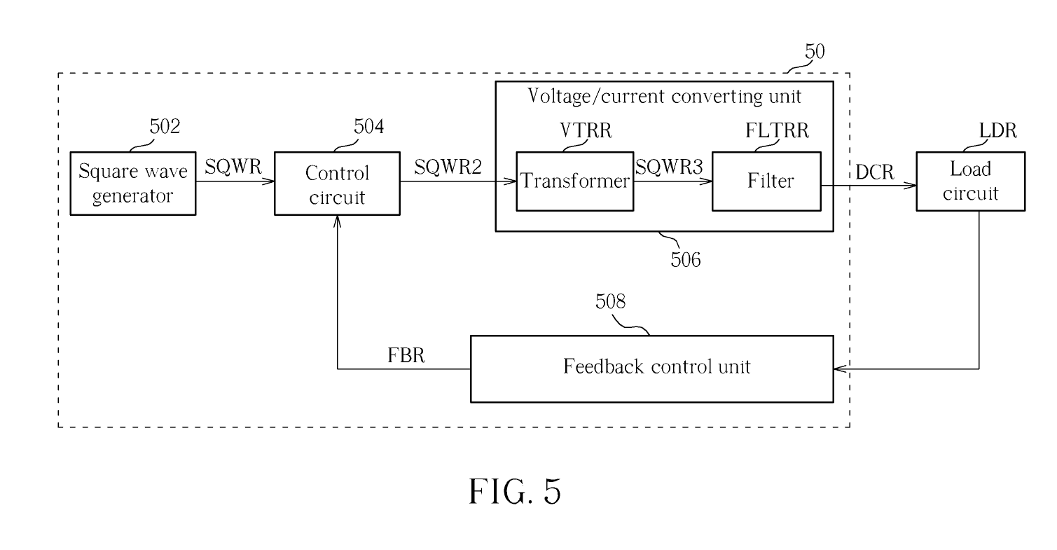

The power supply device 20 is being used in a LCD display device to provide AC and DC power sources to the backlight module and other electronic components. The present invention further provides a DC power supply device according to the power supplying process 40. Please refer to FIG. 5, which illustrates a schematic diagram of a power supply device 40 according to an embodiment of the present invention. The power supply device 50 comprises a square wave generator 502, a control circuit 504, a voltage/current converting unit 506 and a feedback control unit 508. The square wave generator 502 is utilized for generating an oscillating signal SQWR. The control circuit 504 is utilized for masking the oscillating signal SQWR and generating the oscillating signal SQWR2 according to the feedback signal FBR. The voltage/current converting unit 506 is utilized for converting the oscillating signal SQWR2 into a voltage source DCR and supplying a load circuit LDR. The feedback control unit 508 is utilized for detecting the load current in the load circuit LDR and generating the feedback signal FBR. Preferably, the oscillating signal SQWR is a series of square wave signal, and the duty cycle of the square wave is a constant; the voltage source DCR is preferably be a DC voltage source. Also, the voltage/current converting unit 506 comprises a transformer VTRR and a filter FLTRR. The transformer is utilized for transforming the voltage level of the oscillating signal SQWR2 to generate the oscillating signal SQWR3. The filter FLTRR is utilized for converting the oscillating signal SQWR3 into a voltage source DCR.

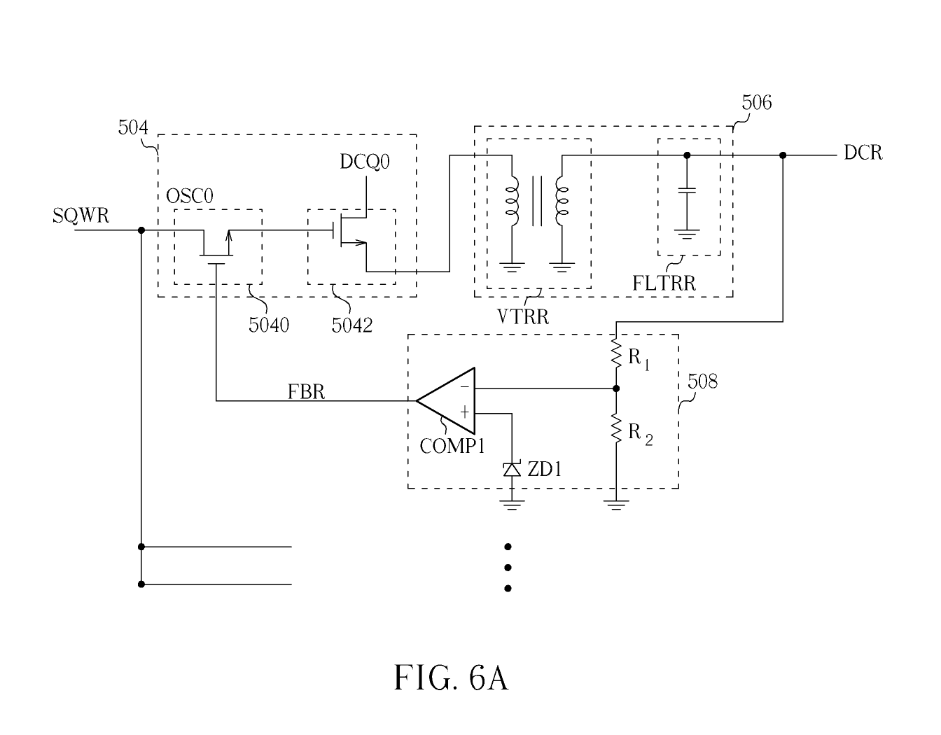

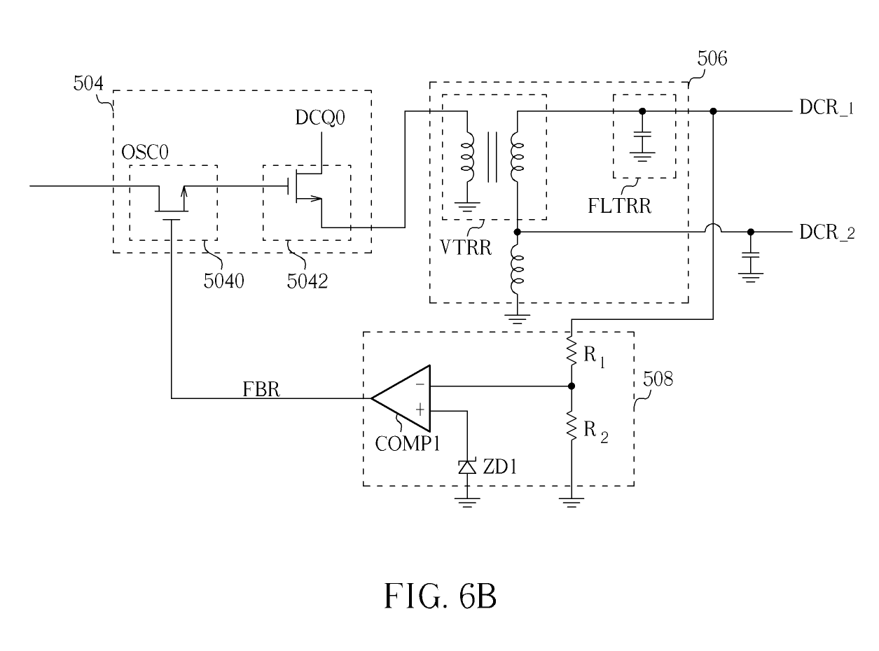

Please refer to FIG. 6A˜6B, which illustrate circuit diagrams of the power supply device 50 according to the embodiment of the present invention. First of all, the control circuit 504 comprises a switch 5040 and a power output circuit 5042; preferably, the switch 5040 of the control circuit 504 is a metal oxide semiconductor field-effect transistor (MOSFET), wherein the gate of the switch 5040 receives the feedback signal FBR output from the feedback control unit 508, and is used for masking off the oscillating signal SQWR. Next, the power output circuit 5042 of the control circuit 504 is also a MOSFET, and is utilized for driving the voltage/current converting unit 506. The filter FLTRR of the voltage/current converting unit 506 is a capacitor, and the transformer VTRR is a voltage transformer. The feedback control unit 508 comprises voltage divider resistors R1 and R2, a comparator COMP1 and a Zener diode ZD1. The Zener diode ZD1 is utilized for supplying a stable reference voltage. When the voltage of the load is lower than the desired value, the feedback control unit 508 can use the feedback signal FBR to turn on the switch 5040 of the control circuit 504; on the other hand, if the voltage of the load is higher than the desired value, the feedback control unit 508 can also use the feedback signal FBR to turn off the switch 5040 of the control circuit 504 and mask off the oscillating signal SQWR. Meanwhile, for clarity, the square wave generator 502 of the power supply device 50 is not shown in FIG. 6A, and the operating principles and realization of the square wave generator 502 have been well known by those skilled in the art, and won't be detailed further. Next, the operating principles and realization of FIG. 6B is almost identical to those of FIG. 6A; the only difference is that the secondary side of the transformer VTRR has two voltage output ends for supplying two different levels of DC voltages DCR1 and DCR2 to different circuit components. By applying the circuit depicted in FIG. 6B, the circuit components can be saved even further.

Therefore, the power supply device 50 can use the square wave generator 502 to generate an oscillating signal SQWR, and mask off portions of the oscillating signal SQWR to regulate the power being delivered to the load circuit LDR. Similar to the power supply device 50, the power supply device 50 can greatly simplify the complexity of the power supply circuit architecture and the cost.

To sum up, the present invention discloses a way to utilize less number of stages of voltage/current conversion and still generate the required voltage/current levels to all the electronic components on the electronic appliances, such that the efficiency of the power conversion can be improved and the component cost can be decreased.

Those skilled in the art will readily observe that numerous modifications and alterations of the device and method may be made while retaining the teachings of the invention.

What is claimed is:

1. A power supply device of a LCD (liquid crystal device) display device comprising:
an AC (alternating current) rectifier, coupled to an AC power source, for transforming the AC power source into a DC power source;
a square wave generator, coupled to the AC rectifier, for generating a first oscillating signal according to the DC power source;
an AC voltage converting module, coupled to the square wave generator, for providing an AC voltage to a backlight module of the LCD display device; and
a plurality of DC voltage converting modules, for providing a plurality of voltage sources to a plurality of load circuits of the LCD display device, each DC voltage converting module comprising:
a control circuit, coupled to the square wave generator, for masking off the first oscillating signal, to generate a second oscillating signal according to a feedback signal of a corresponding load circuit;
a voltage converting unit, coupled to the control circuit and the load circuit, for transforming the second oscillating signal into a voltage source for the load circuit; and
a feedback control unit, coupled to the control circuit and the load circuit, for generating the feedback signal.

2. The power supply device of claim 1 further comprising:
a control circuit, comprising a first end, coupled to the square wave generator, a second end, coupled to the feedback control unit, and a third end, for masking off the first oscillating signal, to generate an AC oscillating signal according to a feedback signal of the backlight module;
a voltage transformer, comprising a first end, coupled to the control circuit, and a second end, coupled to the backlight module, for increasing the voltage level of the AC oscillating signal to drive a light tube of the backlight module; and
a feedback control unit, coupled to the control circuit and the backlight module, for generating the feedback signal.

3. The power supply device of claim 2, wherein the control circuit comprises:
a switch, comprising a first end, coupled to the first end of the control circuit, a second end, coupled to the second end of the control circuit, and a third end; and
a power output circuit, comprising a first end, coupled to the DC power source, a second end, coupled to the third end of the switch, and a third end, coupled to the third end of the control circuit.

4. The power supply device of claim 3, wherein the switch is an n-type metal oxide semiconductor field-effect transistor (NMOS), the first end is a drain, the second end is a gate, and the third end is a source.

5. The power supply device of claim 3, wherein the power output circuit is an n-type metal oxide semiconductor field-effect transistor (NMOS), the first end is a drain, the second end is a gate, and the third end is a source.

6. The power supply device of claim 1, wherein the control circuit of each DC voltage converting module comprises:
a switch, comprising a first end, coupled to the first end of the control circuit, a second end, coupled to the second end of the control circuit, and a third end; and
a power output circuit, comprising a first end, coupled to the DC power source, a second end, coupled to the third end of the switch, and a third end, coupled to the third end of the control circuit.

7. The power supply device of claim 6, wherein the switch is an n-type metal oxide semiconductor field-effect transistor (NMOS), the first end is a drain, the second end is a gate, and the third end is a source.

8. The power supply device of claim 6, wherein the power output circuit is an n-type metal oxide semiconductor field-effect transistor (NMOS), the first end is a drain, the second end is a gate, and the third end is a source.

9. The power supply device of claim 1, wherein the voltage converting unit of each DC voltage converting module comprises:
a transformer, for transforming a voltage of the second oscillating signal to generate a third oscillating signal; and
a filter, coupled to the transformer, for transforming the third oscillating signal into the voltage source.

10. The power supply device of claim 1, wherein the first oscillating signal is a series of square wave signals, and a duty cycle of each square wave signal is a constant.

11. The power supply device of claim 1, wherein the voltage source is a DC voltage source.

12. A power supply method, for supplying a voltage source to a load circuit, comprising:
generating a first oscillating signal;
masking the first oscillating signal to generate a second oscillating signal according to a feedback signal of the load circuit; and
transforming the second oscillating signal into the voltage source for the load circuit.

13. The power supply method of claim 12, wherein the first oscillating signal is a series of square wave signals, and a duty cycle of each square wave signal is a constant.

14. The power supply method of claim 12, wherein the voltage source is a DC voltage source.

15. A power supply device, for supplying a voltage source to a load circuit, comprising:
a square wave generator, for generating a first oscillating signal;
a control circuit, coupled to the square wave generator, for masking off the first oscillating signal, to generate a second oscillating signal according to a feedback signal of the load circuit;
a voltage converting unit, coupled to the control circuit and the load circuit, for transforming the second oscillating signal into a voltage source for the load circuit; and
a feedback control unit, coupled to the control circuit and the load circuit, for generating the feedback signal.

16. The power supply device of claim 15, wherein the control circuit comprises:
a switch, comprising a first end, coupled to the first end of the control circuit, a second end, coupled to the second end of the control circuit, and a third end; and
a power output circuit, comprising a first end, coupled to the DC power source, a second end, coupled to the third end of the switch, and a third end, coupled to the third end of the control circuit.

17. The power supply device of claim 16, wherein the switch is an n-type metal oxide semiconductor field-effect transistor (NMOS), the first end is a drain, the second end is a gate, and third end is a source.

18. The power supply device of claim 16, wherein the power output circuit is an n-type metal oxide semiconductor field-effect transistor (NMOS), the first end is a drain, the second end is a gate, and the third end is a source.

19. The power supply device of claim 15, wherein the voltage converting unit comprises:
a transformer, for transforming the voltage of the second oscillating signal to generate a third oscillating signal; and
a filter, coupled to the transformer, for transforming the third oscillating signal into the voltage source.

20. The power supply device of claim 1, wherein the first oscillating signal is a series of square wave signals, and a duty cycle of each square wave signal is a constant.

21. The power supply method of claim 15, wherein the voltage source is a DC voltage source.
